(19) United States
(12) Patent Application Publication
(10) Pub. No.: US 2012/0291455 A1
(43) Pub. Date: Nov. 22, 2012

(54) METHOD AND APPARATUS FOR MOVING CRYOGEN

(76) Inventors: Bryce M. Rampersad, Bloomingdale, IL (US); Jeffrey R. Wallace, Naperville, IL (US)

(21) Appl. No.: 13/110,381

(22) Filed: May 18, 2011

(51) Int. Cl. F17C 13/00

(52) U.S. Cl. 62/50.6

(57) ABSTRACT

Method and apparatus for moving liquid cryogen at relatively low pressures and at high volumes. An axial rotor pump may have housing with a substantially vertical tubular space. The axial rotor pump may pump liquid cryogen from an inlet near a bottom of the housing to an outlet near a top of the housing. A seal may not be required between a pump drive shaft and the top of the pump housing by using an extended neck or a magnetic coupling arrangement.

### FIELD OF THE INVENTION

The present invention relates to system and method for delivering liquid cryogen at relatively low pressure and at high volumes, and more particularly, to a low pressure, high volume axial rotor cryogenic pump suitable for use in many food chilling and freezing applications.

### BACKGROUND

The use of cryogenic fluids in food chilling and freezing applications has presented special problems in the design and application of pumping equipment for such applications. The challenges associated with minimizing pumping losses and maintaining the cryogen in liquid form during the pumping process has been particularly difficult to overcome. Inefficient cryogenic pumps tend to heat the cryogen, causing boiling and cavitation in the fluid lines that may diminish the effectiveness of the pump, decrease the lifespan of the pump and/or cause excessive waste of liquid cryogen.

The inventors have appreciated that in some applications, it may be desirable to provide a specially designed axial rotor pump that operates to efficiently move liquid cryogen at relatively low pressure and at high volumes. Providing liquid cryogen at low pressure and high volumes is one way to efficiently move liquid cryogen in food chilling and freezing applications, while minimizing cryogen loss and maximize the cooling effect of the liquid cryogen.

### SUMMARY OF INVENTION

One aspect of the invention relates to a pump constructed and arranged to pump a liquid cryogen for an extended period of at least several hours. In one embodiment, the pump may include a housing with a substantially vertical tubular space. The pump inlet may be located near a bottom of the tubular space and an outlet may be positioned above the bottom. The housing may contain a drive shaft connected to an axial rotor that is arranged to be rotated by the drive shaft to pump liquid cryogen from the inlet toward the outlet. In another embodiment, shaft stays may be located inside the housing to help maintain alignment of the drive shaft with respect to the pump housing.

In another aspect of the invention, the pump is constructed such that a seal is not required between the drive shaft and the top of the pump housing. In one embodiment, the top of the housing includes a clearance hole that permits the drive shaft to seallessly pass through the housing. In some embodiments, the tubular space of the housing also includes an extended neck between the pump outlet and the top of the housing. This extended neck may be constructed and arranged to be positioned above the highest level of head that can be generated at the pump outlet. In another embodiment, a magnetic coupling may couple the drive shaft to a motor shaft connected to a motor located outside the housing where a hermetic, non-pass-through seal may be used to contain the liquid cryogen in the pump housing.

In another aspect of the invention, the drive shaft may be supported by bearings. The bearings may be sleeve bearings. The sleeve bearings may be graphite plug-impregnated brass bearings where the graphite plugs provide a dry lubrication to the pump shaft.

One aspect of the invention relates to a method of pumping a liquid cryogen using an axial pump. The pumping may occur for at least several hours. The liquid cryogen may be pumped to a conveyor belt that may support products to be cooled and/or frozen.

These and other aspects of the invention will be apparent from the following detailed description and claims.

### BRIEF DESCRIPTION OF THE DRAWINGS

Aspects of the invention are described with reference to illustrative embodiments and to the drawings in which like numerals reference like elements, and wherein:

FIG. 1 shows a material cooling system including a cryogen supply system in accordance with aspects of the invention;

FIG. 2 shows an embodiment in which the material cooling system includes a conveyor belt;

FIG. 3 shows an embodiment in which the cryogen supply system includes an agitator;

FIG. 4 shows an embodiment in which the cryogen supply system includes a wave generator;

FIG. 5 shows an embodiment in which the cryogen supply system includes a sparger;

FIG. 6 shows an embodiment in which the cryogen supply system includes a distributor plate, a plenum, and a pump;

FIG. 7 is a perspective view of selected components of the material cooling system shown in FIG. 6;

FIG. 8 is an overhead view of selected components of the material cooling system shown in FIG. 6;

FIG. 9A shows an embodiment in which the conveyor belt includes a rod belt and a solid belt;

FIG. 9B shows an overhead view of the combined rod belt and solid belt with a cutaway of the solid belt to reveal the rod belt beneath;

FIG. 10 shows an embodiment in which the cryogen supply system includes an axial rotor pump with an extended neck;

FIG. 11 shows a perspective view of the axial pump rotor;

FIG. 12 shows an embodiment in which the cryogen supply system includes an axial rotor pump with a magnetic coupling;

FIG. 13A shows an embodiment in which the axial rotor pump includes shaft stays;

FIG. 13B is a detailed overhead view of the shaft stays inside the axial rotor pump.

### DETAILED DESCRIPTION

The inventors have appreciated that the known configurations for the refrigeration of food products may, in some cases, have undesired outcomes or consequences. For example, tunnel freezer systems typically use metal mesh conveyor belts that have holes or other openings in the surface on which products are placed. Thus, in some cases, freezing products in a conventional tunnel freezer may result in forming belt marks on the product, loss of product shape, product damage, and drip and moisture losses to the product. In those systems mentioned above in which a plastic sheet is drawn across a refrigerated plate, the plastic sheeting may be a significant expense because it is typically only used once then discarded. In addition, immersion of the return portion of a conveyor belt may provide poor control of the belt surface temperatures, e.g., in regions where the belt surface supports the products as the regions move through the freezer. Additionally, immersion of the product with the active portion of a conveyor belt may result in decreased quality of the product due to excessive and/or non-uniform freezing and/or contamination of the cryogen due to contact with the product. In some embodiments that incorporate one or more aspects of the invention, a freezer system may avoid making belt marks on a product, may avoid the need for using a plastic sheet or other material interposed between the product to be frozen and a chilling conveyor belt and/or may provide for relatively tight control of freezing surface temperatures. However, as discussed in more detail below, some or all of these features need not be provided in all embodiments that incorporate one or more aspects of the invention.

Various aspects of the invention are described below and/or shown in the drawings. These aspects of the invention may be used alone and/or in any suitable combination with each other. Aspects of the invention are not limited in any way by the illustrative embodiments shown and described herein.

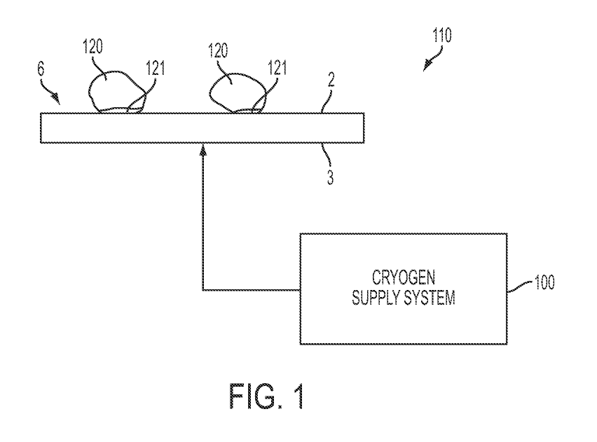

FIG. 1 shows a cooling system 110 that incorporates various aspects of the invention. This illustrative embodiment includes a cooling element 6 with an outer surface 2 and an inner surface 3. (The terms outer and inner are used herein for convenience and ease of reference and understanding. However, it should be understood that these terms should not necessarily limit the relative positions or locations of the surfaces. For example, the outer surface need not necessarily define the outside or extreme outer part of a component. Instead, the outer surface 2 is that surface presented for support of a product, while the inner surface 3 is the surface opposite the outer surface 2.) The cooling element 6 may be a static element or a moving element, e.g., as part of a conveyor belt. The outer surface 2 may support a material 120 to be cooled, such as a food product. In accordance with an aspect of the invention, a cryogen supply system 100 may provide liquid cryogen in bulk liquid contact directly to the inner surface 3. The application of liquid cryogen directly to the inner surface 3 may, in some embodiments, cool the entire element 6, including the outer surface 2. In other arrangements, the cryogen may be applied so as to cool only selected portions of the cooling element 6 and/or the outer surface 2. As discussed in more detail below, the cryogen supply system 100 may apply liquid cryogen to the inner surface 3 of the cooling element 6 in any suitable way, such as splashing cryogen onto the inner surface 3, directing cryogen from one or more nozzles or other outlets onto the inner surface 3, immersing the inner surface 3 in a cryogen bath, and/or in other ways. In some embodiments, the liquid cryogen may contact the inner surface of the belt at different locations along the belt, creating several discrete contact regions where the liquid cryogen is in contact (e.g., bulk liquid contact) with the inner surface 3. While in some embodiments, liquid cryogen may be applied in bulk liquid contact to only the inner surface 3, other additional cooling features may be provided as well, such as a liquid cryogen sprayed to the outer surface 2.

Materials 120 provided onto the cooled outer surface 2 may become frozen or otherwise chilled at the region of contact 121 with the cooled outer surface 2, as well as at other portions of the material 120, which may be cooled by thermal conduction, convection and/or radiation.

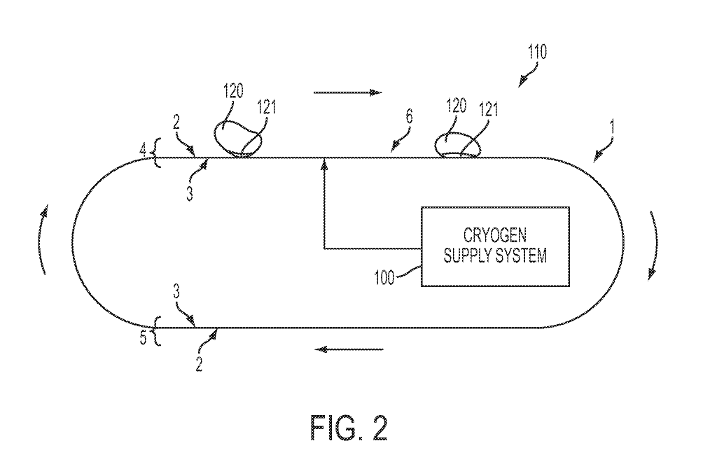

In some embodiments, the cooling element 6 can be an active region 4 of a conveyor belt 1, as shown in FIG. 2. The conveyor belt 1 may include an active region 4 and a return region 5. The active region 4 may be that portion of the conveyor belt 1 that is constructed and arranged to support materials 120. In contrast, the return region 5 may be a portion of the conveyor belt 1 that does not support materials 120, e.g., may be a portion that moves to return back to the active region 4. Thus, depending on their relative locations at any one point in time, parts of a conveyor belt 1 may be part of an active region 4, move to a return region 5, and later again become part of the active region 4. The conveyor belt 1 may be a solid belt, a rod belt, a wire belt, a mesh belt, a combination of such structures, or any other suitable arrangement. Thus, in some embodiments, the outer surface 2 of the active region 4 may have no holes or other openings where materials 120 are supported, e.g., may be solid. This arrangement may help prevent contact of the cryogen applied to the inner surface 3 with the materials 120 (which might otherwise cause contamination or other damage to the materials 120 and/or cryogen). Alternately, the outer surface 2 may have holes or other openings, as desired. The conveyor belt 1 may also include both a solid belt and a rod belt, as will be discussed below.

The cryogen supply system 100 can provide cryogen to the inner surface 3 in a variety of arrangements, as discussed above and will be illustrated in more detail below. In several of the embodiments described, the active region 4 of the conveyor belt 1 may move material 120 through a tunnel freezer for cooling a product as well as other processes. It should be understood, however, that a tunnel freezer is neither a required nor a necessary feature. Instead, aspects of the invention may be used in any suitable environment and for any suitable purpose other than chilling a food product.

Previously known freezing arrangements, such as in U.S. Pat. Nos. 5,467,612 and 5,460,015, disclose the use of cryogen spray nozzles to spray liquid cryogen onto the underside of a conveyor belt. The non-vaporized liquid cryogen exits from these spray nozzles in a series of individual droplets. In contrast, in one aspect of the invention, liquid cryogen is provided in direct, bulk liquid contact with the inner surface 3 of the cooling element 6. The term bulk liquid contact is used to mean contact with the element using a contiguous volume of liquid, as opposed to distinct and separate liquid droplets. In some embodiments, volumes of liquid cryogen that are in bulk liquid contact with the cooling element 6 may be contiguous with a plenum holding a relatively large volume of liquid cryogen, e.g., of several gallons or more. In other embodiments, volumes of liquid cryogen that are in bulk liquid contact with the cooling element 6 may have a volume of about 10-15 ml or more.

Additionally, nozzle-type spray configurations like that in U.S. Pat. Nos. 5,467,612 and 5,460,015 require storage of liquid cryogen at pressures of around 20 psi or greater, and, during operation of the freezing process, delivery of liquid cryogen occurs through spray nozzles at pressures around 40-60 psi. The disadvantage of pressurizing liquid cryogen during storage and/or delivery to an object to be cooled is loss of refrigeration capacity of the cryogen. In one aspect of the invention, liquid cryogen can be stored and supplied to a support for cooling at pressures less than about 20 psi, thereby decreasing the loss of refrigeration capacity of the cryogen due to pressurization.

Also, spray nozzles generally output liquid cryogen with high kinetic energy. In contrast, in one aspect of the invention, liquid cryogen is provided in direct contact with the inner surface 3 of the cooling element 6 at nearly zero velocity. By nearly zero velocity, it is meant that the velocity of the liquid cryogen is very small when it contacts the inner surface 3 of the cooling element 6; much smaller than the velocity of liquid cryogen from a spray nozzle.

In some embodiments, liquid cryogen is provided to at least portions of the inner surface 3 in the active region 4 from a plenum. The plenum may be any vessel suitable for holding liquid cryogen and may be of various depths or other dimensions, shapes and/or volumes.

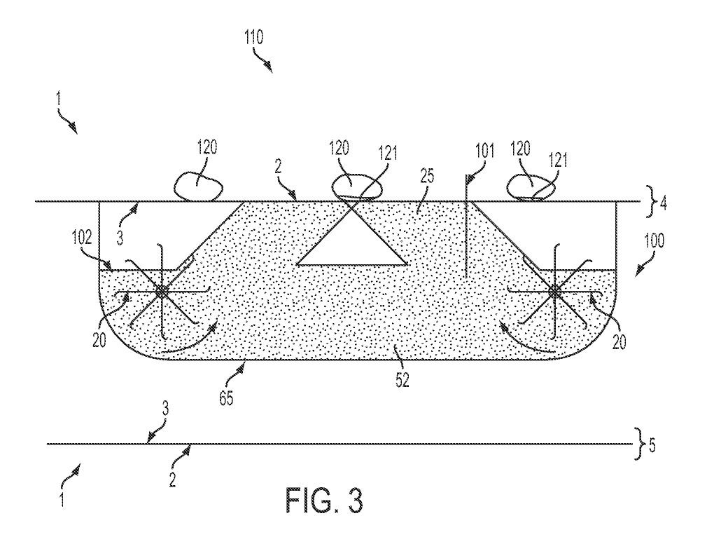

In the illustrative embodiment of FIG. 3, the cryogen supply system 100 includes a plenum 65 suitable for holding liquid cryogen 52 and a rotating mechanical agitator 20 or multiple agitators. In this embodiment, the agitators 20 may be partially or completely submerged in liquid cryogen 52, and may take the form of a rotating paddle wheel or similar arrangement. The agitators 20 may splash cryogen 52 and provide direct, bulk liquid contact of liquid cryogen with the inner surface 3 in the active region 4. This splash 25 and subsequent bulk liquid contact may cause all or a part of the active region 4 of the conveyor belt 1 to be cooled, including the outer surface 2 in the active region 4. Materials 120 that are supported by the cooled outer surface 2 in the active region 4 may become frozen or otherwise chilled at the region of contact 121 with the cooled outer surface 2, although additional portions of the material may become frozen or chilled as well. The agitator(s) 20 may take other forms, such as reciprocating paddles, vanes or other elements that move the cryogen toward the inner surface 3. During this process, some cryogen may be vaporized (e.g., due to heat transfer between the active region 4 and the cryogen and/or other heat introduced to the cryogen) while other portions may remain in bulk liquid form. Non-vaporized cryogen may fall back into the container 50 for use again in cooling the active region 4. If the materials 120 are arranged to move through a tunnel freezer, vaporized cryogen may be circulated in a tunnel freezer to provide additional cooling to the top of the material 120, thereby increasing the cooling capacity of the cryogen. A cryogen level 102 may be maintained in the plenum 65 for the operation of the system using a suitable level controller 101 and an external cryogen source (not shown). For example, the level controller 101 may include one or more sensors that detect an upper surface of the cryogen 52 (e.g., by optical, temperature, electrical conductivity and/or other techniques), and an electrically-controlled valve that can be opened to allow cryogen to flow from a supply tank to the plenum 65.

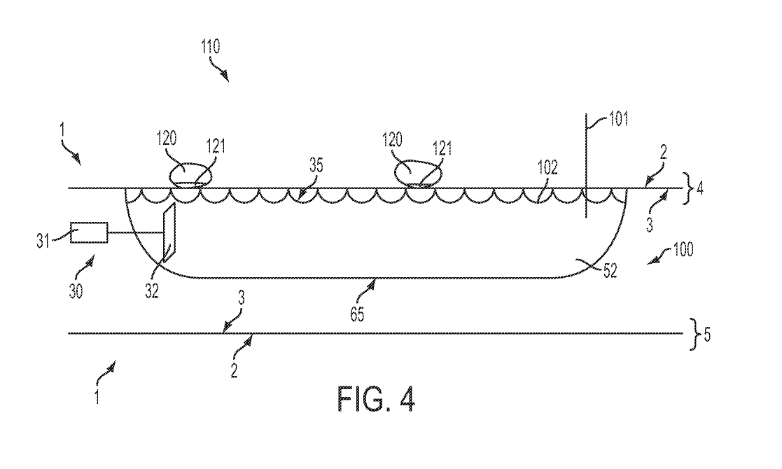

In another embodiment shown in FIG. 4, the cryogen supply system 100 may include a plenum 65 suitable for holding a liquid cryogen 52 and a wave generator 30, which may include one or more components that are partially or completely submerged in liquid cryogen 52. For example, the wave generator 30 may include a plate 32 attached to an actuator 31 (such as a motor and drive arm that can operate to oscillate the plate 32), or any similar arrangement. The plate 32 may be a single, flat, nearly vertical plate. In other embodiments, the plate may be curved or shaped into other forms. The plate 32 may be positioned at one end of the plenum 65 and the actuator 31 may move the plate 32 back and forth horizontally, or in any suitable arrangement, to generate waves 35 on the surface of the liquid cryogen 52. The inner surface 3 in the active region 4 may be wetted by liquid cryogen during bulk liquid contact with one or more crests or other portions of waves 35. The wave generator 30 may create a plurality of discrete contact regions where the liquid cryogen is in bulk liquid contact with the inner surface 3. The waves 35 could be generated to remain stationary, to move in a direction that is opposite to the direction of movement of the active region 4 of the conveyor belt 1, and/or to move in a direction along with the movement of the active region 4 to provide potentially more uniform cooling of the materials 120. The wave generator 31 and plenum 65 may be arranged to create a standing wave in the plenum 65, which may require a relatively small amount of energy to generate and maintain. The standing wave could be generated by a single wave generator by adjusting the frequency of actuation until a standing wave is produced. In other embodiments, a standing wave could be created by using two wave generators positioned at opposite ends of the plenum 65, or by other suitable arrangements. For at least some standing wave arrangements, the liquid cryogen that contacts the inner surface 3 in the active region 4 may have a nearly zero upward velocity at the contact point.

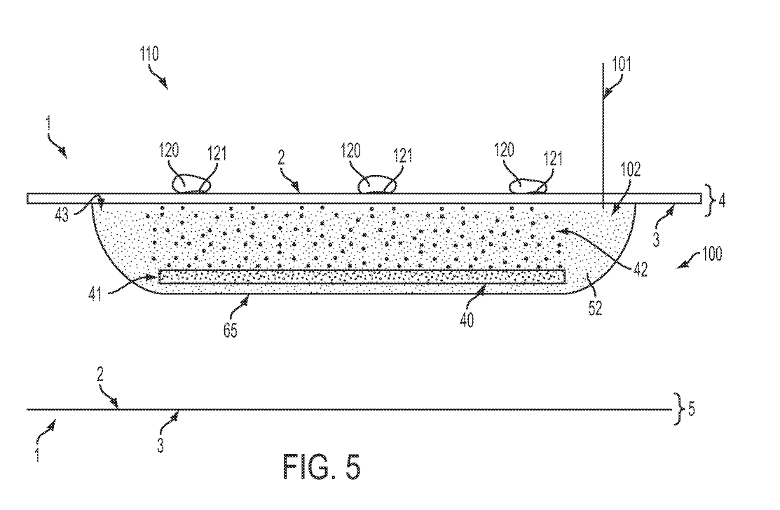

In another embodiment shown in FIG. 5, the cryogen supply system 100 may include a plenum 65 suitable for holding a liquid cryogen 52 and a sparger 40 or multiple spargers. In this embodiment, the sparger 40 may be partially or completely submerged in liquid cryogen 52. A suitable gas 41 such as nitrogen gas may flow through the sparger 40 and may create a multitude of bubbles 42. Many other gases may be used for sparging, however, and is not limited in this regard. The bubbles 42 may be produced at random, periodically, in sheets, in groups, in spots, or in other arrangements. The bubbles 42 may rise through the cryogen plenum 65 and burst as they break through the surface 43 of the cryogen. These bursts may cause wetting of the inner surface 3 in the active region 4. The bursts may also produce waves and/or currents that may also cause bulk liquid wetting of the inner surface 3 in the active region 4.

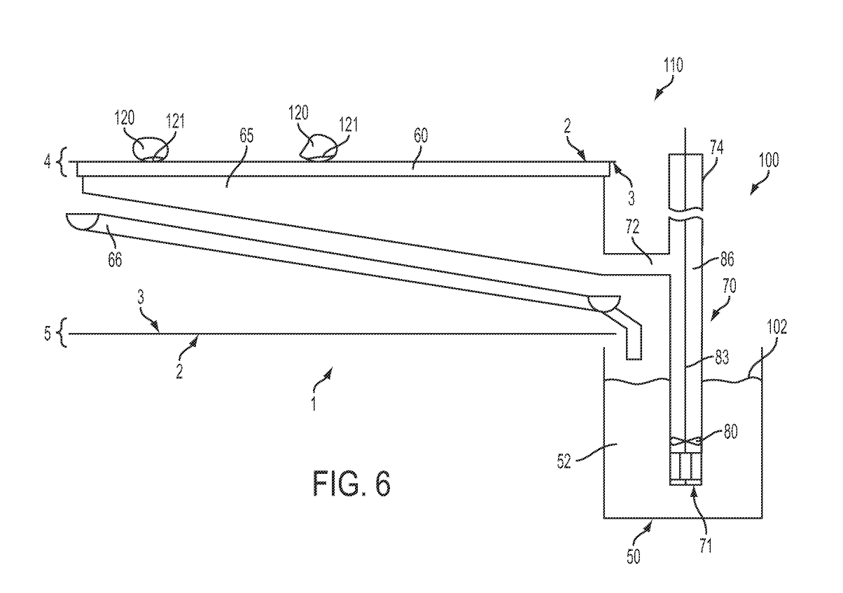

In yet another embodiment shown in FIG. 6, the cryogen supply system 100 may include an element that helps to evenly or otherwise distribute cryogen to the inner surface 3 in the active region 4. A conveyor belt 1 with an active region 4 may be positioned above a grooved distributor plate 60 that is positioned above a plenum 65 in any suitable arrangement. Non-vaporized cryogen may fall back from the active region 4 down into a cryogen return 66 that may guide the non-vaporized cryogen back into the container 50 for use again in cooling the inner surface 3. The cryogen return 66 may comprise any suitable means for returning cryogen to the container 50, such as a gravity feed or an agitator, and is not limited in this regard. A gravity feed system may comprise any suitable element, such as a gutter, a pipe, or a tube. A gravity feed cryogen return 66 may be constructed of a sheet of material such as stainless steel or any other suitable material. The cross-sectional shape of the cryogen return may be semicircular, rectangular, square, ellipsoid, or any suitable arrangement. The cryogen return may be slanted downward into the container at a slight angle, a steep angle, or other arrangement.

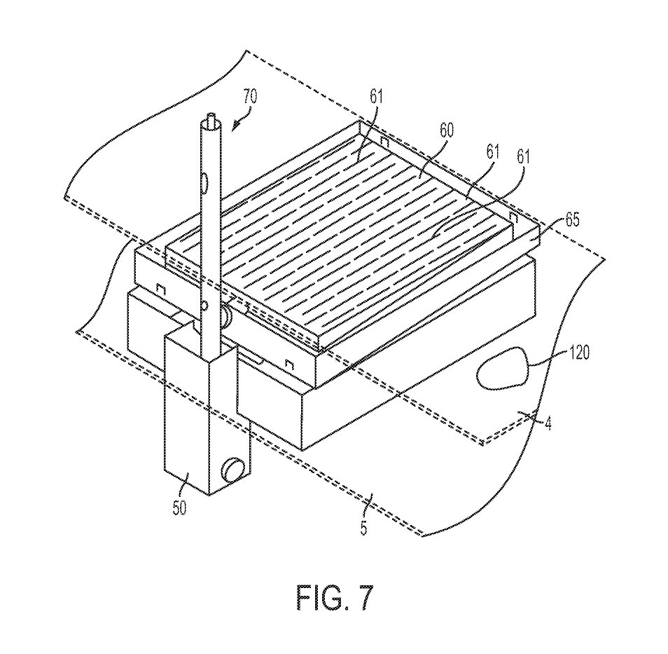

Liquid cryogen may be provided into the plenum 65 from a cryogen-holding container 50 by a prime mover, such as a pump 70. The prime mover may consist of a pump, a gravity feed, an agitator, or any other suitable element. The liquid cryogen provided from the container 50 to the plenum 65 may enter a grooved distributor plate 60 from below and exit out the top of the distributor plate 60 through grooves 61, as shown for example in FIG. 7. The grooved distributor plate 60 may help to direct a flow of liquid cryogen from the grooves 61 toward the inner surface 3 of the conveyor belt 1 in the active region 4. In addition, the grooved distributor plate 60 may function to help distribute the liquid cryogen provided to the plenum 65 to the inner surface 3 of the belt 1 more evenly and thoroughly, in selected regions of the inner surface 3 and/or in other ways. The grooves 61 may include any suitable geometry and type of opening, for example, slots, simple round holes, penetrations, through-holes, etc., and the grooves 61 may also include one or more channels, pathways or other features to help move the cryogen to desired locations of the inner surface 3. The size, diameter, and/or length of the grooves 61 may vary as well. As shown in FIG. 7, in one embodiment, the grooves 61 may stretch across the entire width of the plate, transverse to the direction of the moving belt. The grooves may have a width of about 0.05 inches, and may be spaced about 2 inches from one another in the direction that is transverse to the direction of the moving belt. However, it should be understood that is only one embodiment, and a range of different widths and spacings, as well as variations in groove size, shape and configuration is possible.

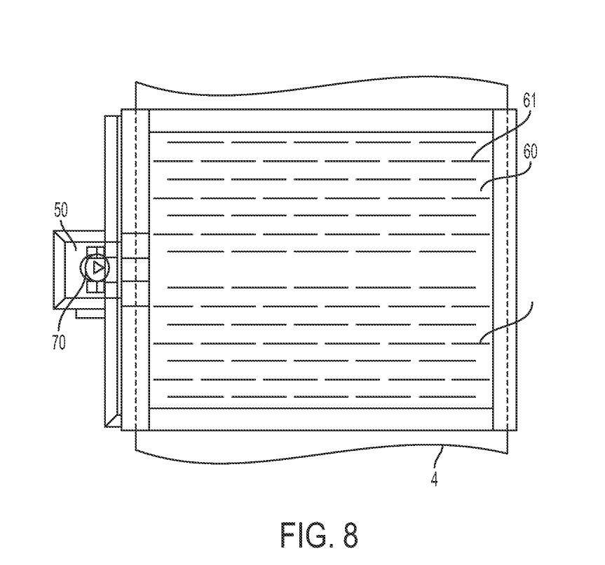

The distribution grooves 61 on the distributor plate 60 may allow cryogen to be evenly distributed along the inner surface 3 in the active region 4 as cryogen exits the distributor plate 60. In some embodiments, the grooves may be arranged to supply more cryogen to particular portions of the inner surface 3 and provide a non-even distribution along the inner surface 3. The spacing between grooves may also vary. The grooves 61 may be spaced closely together, far apart, uniformly spread out over the distributor plate 60, and/or without any regular pattern. The distribution of grooves 61 may also be arranged in a variety of configurations. FIGS. 7 and 8 show one possible configuration in which the distribution grooves 61 may extend across the entire distributor plate 60. Many other groove arrangements are possible and are not limited to these illustrative configurations.

In some arrangements, the prime mover 70 may provide liquid cryogen through the distributor plate in direct, bulk liquid contact with the inner surface 3 of the active region 4. In some arrangements, a 0.5 to 1.0 inch throw of liquid cryogen above the distributor plate 70 is enabled by the prime mover 70, e.g., the liquid cryogen may move upwardly above the plate 70 about 0.5 to 1 inch before being stopped and moved downwardly away from the belt by gravity (unless the cryogen strikes the inner surface 3 prior to being stopped in upward movement by gravity). In some embodiments, the distance between the plate and the belt may be arranged to equal the throw distance of liquid cryogen above the plate, causing the cryogen to contact the belt at approximately the maximum trajectory height of the liquid cryogen, at which the velocity of the moving cryogen is nearly zero. In this arrangement, the liquid cryogen that contacts the inner surface 3 may have nearly zero velocity. The distributor plate 70 may create a plurality of discrete contact regions where the liquid cryogen is in bulk liquid contact with the inner surface 3.

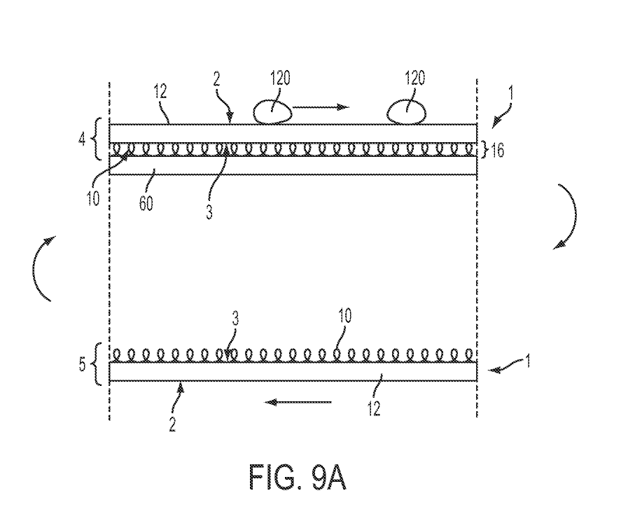

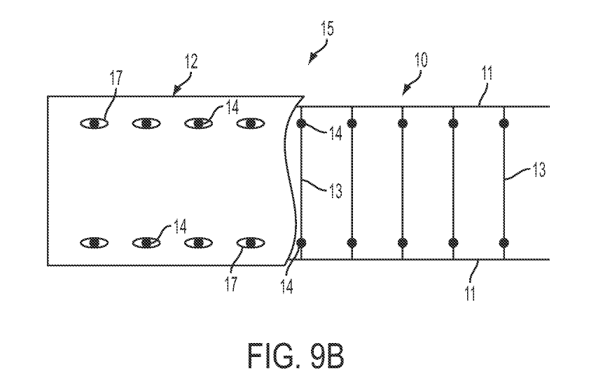

As mentioned previously, the conveyor belt 1 may include various components. In one arrangement, the conveyor belt 1 may include a rod belt 10 underlay combined with a solid belt overlay 12, as shown in FIG. 9A. In the active region 4, the solid belt 12 may be positioned above the rod belt 10. In the return region 5, the solid belt 12 may be positioned below the rod belt 10. In the active region 4, this combined conveyor belt arrangement may be positioned on top of the distributor plate 60. The rod belt 10 may provide a gap 16 between the distributor plate 60 and the solid belt 12. This gap 16 may provide a 3/16 inch spacing between the plenum and the distributor, although a range of spacing is possible and is not limited in this regard. This gap 16 may be useful for helping vaporized cryogen (gas) escape or otherwise be vented from the space between the distributor plate 60 and the solid belt 12 while allowing liquid cryogen to contact the inner surface of the solid belt. In another embodiment where a spacing mechanism is not integrated into the belt, a corrugated grooved distributor can be used where the corrugations provide escape routes for vaporized liquid cryogen and a passage for excess liquid cryogen.

As shown in FIG. 9B, the solid belt 12 may be a flat, thin sheet made of stainless steel or any other suitable material and may have no holes or other openings, at least in a region that supports the material 120, e.g., to help prevent direct contact between the cryogen 52 with the material 120 and avoid potential contamination of the cryogen 52 and/or the material 120. The rod belt 10 may consist of two edge chains 11 that form the sides of the rod belt 10. The two edge chains 11 may be connected to one another by a plurality of rods 13. Each rod 13 may have two pins 14 connected to the rod 13, one pin near the first edge chain, and the second pin near the other edge chain. The pins 14 may be of any geometry, shape, diameter, and length. The pins 14 may be constructed of any suitable material, such as a metal. The pins 14 may be attached to the rods 13 by any suitable means, such as by welding, a screw connection, or the pins 14 and rod 10 may have been formed as a single part. The solid belt 12 may include a plurality of slots 17 located along each edge. These slots 17 may be extended slits, simple through holes, narrow or wide channels, or any suitable geometry. The slots 17 may have a range of diameters and depths. In the active region 4, the solid belt 12 lies substantially over the rod belt 10. These pins 14 may align with and penetrate through the plurality of slots 17 located on the solid belt 12. In one embodiment, the slots 17 on the solid belt 12 are wider than the pins 14 to permit the pins 14 to penetrate through the slots 17 with a wide clearance. In this embodiment, the rod belt 10 is able to shift by a limited distance relative to the solid belt 12. The shifting distance between the rod belt 10 and the solid belt 12 is limited by the width of the slot 17. The solid belt 12 is supported and driven by the rod belt 10. The composite conveyor belt 15 may be arranged in many different ways and is not limited to the arrangement shown in FIG. 9B.

The inventor has appreciated that, in some embodiments, it is advantageous to store and deliver liquid cryogen at low pressures to decrease loss of refrigeration capacity of the cryogen due to pressurization. Liquid cryogen may be stored and delivered at low pressures less than about 20 psi, moved to a discharge location and delivered to cool or freeze products. Liquid cryogen may also be stored at medium pressures at about 20 to 50 psi. The discharge location may be at an elevation above the products or other object to be cooled and liquid cryogen may be delivered to the products/object via a gravity feed, rainfall, perforated plate, slits, weirs, overhead nozzle spray, or other suitable arrangement. Additionally, the discharge location may be positioned below the products/object to be cooled and the liquid cryogen may contact the products/object from below by any suitable means such as via a pump, mechanical agitation, wave generation, sparging, nozzle spray, direct immersion of products and/or belt into the liquid cryogen, or other suitable arrangement (e.g., including arrangements discussed above). The liquid cryogen may be delivered to any freezer or other cooling system, such as a solid belt freezer, open belt freezer, static non-moving freezer, or other suitable arrangement.

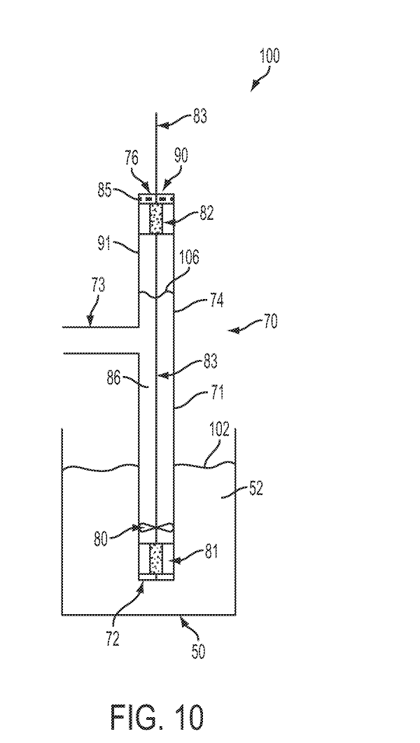

The cryogen supply system 100 in the above embodiments, including FIG. 6, may include any suitable pump or other component to move liquid cryogen, but in one embodiment, the cryogen supply system 100 may include an axial rotor pump 70 like that shown in FIG. 10. Although this pump 70 has been found to be useful in cooling applications like those discussed above, this pump 70 may be used for any suitable application. In any case, the pump 70 is suitably constructed to pump a liquid cryogen for an extended period of at least several hours.

In some embodiments, it may be desirable to provide a pump that operates to efficiently move liquid cryogen at relatively low pressure and at high volumes. The inventor has appreciated that relatively high pump efficiency can be important in some cryogenic applications, e.g., because an inefficient cryogenic pump will heat the cryogen, causing boiling and cavitation that may diminish the effectiveness of the pump, decrease the lifespan of the pump and/or cause excessive waste of liquid cryogen. Providing liquid cryogen at low pressure and high volumes is one way to efficiently move cryogen, e.g., while helping to minimize cryogen loss and maximize the cooling effect. As stated earlier, pressurizing liquid cryogen may decrease the refrigeration capacity of the cryogen. In some embodiments, an axial rotor pump, as shown in FIG. 10, may be used to deliver cryogen at relatively low pressure and high volume. An axial rotor pump is not capable of high heads per stage when compared to other types of pumps, but is more efficient than most pump designs in moving large volumes at low head. The axial rotor pump may move liquid cryogen at pressures less than about 20 psi and deliver a flow rate of between about 20 to 200 gallons per minute. In this embodiment, the axial pump 70 may include an axial rotor 80 placed within a pump housing 71.

In FIG. 10, the pump housing 71 defines a substantially vertical tubular space 86. It should be understood that “substantially vertical” is not limited to perfectly vertical or to any particular orientation. Instead, vertical is used for ease of description and understanding, particularly since a pump like that shown in FIG. 10 will typically be used with the inlet positioned below the outlet. However, it should be understood that the term vertical is not intended to limit the orientation(s) in which the pump may be operated, e.g., the housing 71 may be positioned horizontally in some applications. Thus, the tubular space 86 may be tilted at an angle in any suitable arrangement that allows the pump to continue to function properly. The rotor 80 may have a close clearance fit to or other suitable arrangement with respect to the tubular space 86. For example, the pump housing 71 may be formed at least in part by a 2.5 inch pipe having an outlet 73 above the rotor 80 of approximately the same diameter. A range of diameters is possible for both the pump housing and the outlet however (e.g., from about 0.5 inches to about 4 inches), and is not limited in this regard.

A pump inlet 72 may be located near a bottom of the tubular space and a pump outlet 73 may be located above the bottom, or other suitable arrangement. The axis of the rotor 80 may be arranged along the longitudinal axis of the tubular space 86. The rotor 80 may be connected to a drive shaft 83 such that rotation of the drive shaft 83 causes rotation of the rotor 80. Pump vents 85 may be located on the side of the pump housing 71 near the top 76 to prevent the buildup of pressure at the top of the housing during operation of the pump. Since the axial pump 70 contains relatively few components, the pump may be easily disassembled and reassembled for inspection and cleaning.

In some embodiments, it may be desirable to support the drive shaft 83 with bearings. The inventors have appreciated that bearings are often problematic components of any cryogenic system since the system must operate at extremely low temperatures. A liquid lubricant may not remain in a liquid state at cryogenic temperatures. Thus, bearings utilizing dry lubricant may be desirable. For example, in FIG. 10, bearings 81, 82 may be sleeve bearings made of graphite plug-impregnated brass. As a dry lubricant, graphite is unaffected by the extremely cold temperatures encountered by the pump shaft in the pump housing. However, other bearings materials and configurations can be applied as well, and are not limited in this regard. In addition, in some embodiments, the lower bearing 81 may be positioned either above or below the axial rotor 80. Also, some embodiments may only have one bearing.

In some embodiments, it may be desirable to construct the pump 70 such that a seal is not required between the drive shaft 83 and the top 76 of the pump housing 71. Seals are often made of a supple material. The inventors have appreciated that, in a cryogenic system, a supple material may become brittle and crack during use. Of course, a seal may be used in the pump 70, and the invention is not limited in this regard. In one sealless embodiment, as shown in FIG. 10, the neck 74 of the pump located above the pump outlet 73 is extended vertically upwards such that the length of the extended neck 91 is several inches above the highest head 106 that can be generated at the outlet 73 under typical flow conditions, as shown in FIG. 10. The drive shaft 83 simply exits through the pump housing 71 through a clearance hole 90, and a motor (not shown) can be connected externally to the drive shaft 83. In the operation of this embodiment, a liquid head 106 builds in the extended neck 91 portion of the pump, but the head is never sufficient to push liquid out of the clearance hole 90.

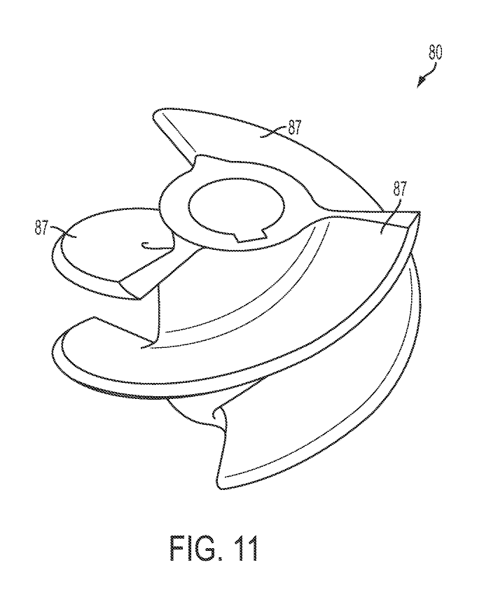

As shown in FIG. 11, in some embodiments, the rotor 80 may include three rotor blades 87, each with a pitch 88 of between a range of about 1 to 3 inches. Each blade 87 may sweep between a range of about 200 to 400 degrees, and the rotor outer diameter may be between about 0.5 to 4 inches. The pitch to diameter ratio range may be between about 0.5 to 1. A range of dimensions is possible for the pitch, blade sweep angle (e.g., at least 45 degrees or more), and rotor outer diameter, however, and is not limited in this regard.

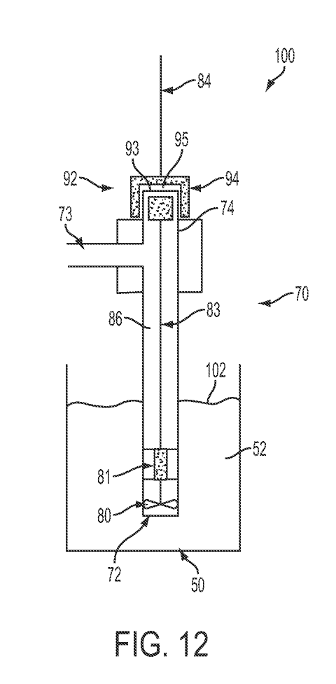

In another sealless embodiment, as shown in FIG. 12, the top of the pump may be fitted with a magnetic coupling 92 where the inner male portion 93 of the magnetic coupling 92 is attached to the drive shaft 83, and the outer female portion 94 of the magnetic coupling 92 is attached to the motor shaft 84. The motor shaft 84 may be connected to a motor (not shown) that rotates the female portion 94, and thereby rotates the male portion 93, drive shaft 83, and the rotor 80. The forces required to rotate the drive shaft 83 and to keep the drive shaft 83 aligned radially are accomplished by the magnetic forces of the magnetic coupling 92. Of course, other couplings or bearings could be used to maintain the radial alignment between the inner male portion 93 and the outer female portion 94. A thin, nonmagnetic stainless steel liquid barrier 95 may be disposed between the inner male portion 93 and outer female portion 94 of the magnetic coupling 92 to prevent cryogen or gas from flowing out of the pump housing 71 when the pump 70 is in operation.

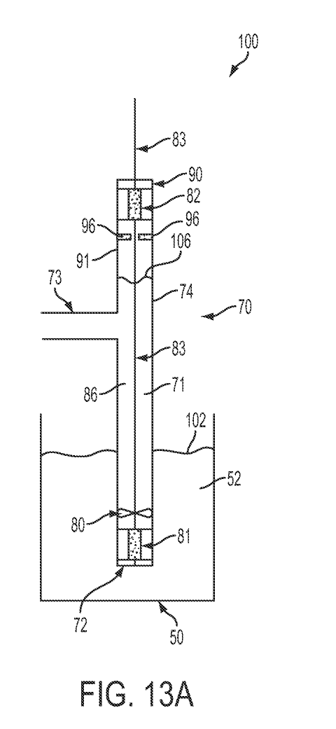

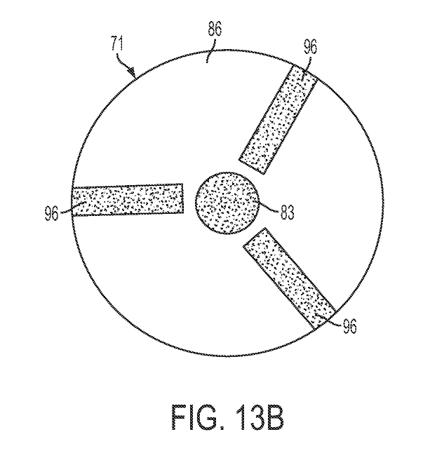

In some embodiments, the pump may include shaft stays 96, as shown in FIG. 13A. The shaft stays may be contained within the pump housing 71 and may be arranged to surround the pump drive shaft 83 in a radial direction, as shown in FIG. 13B. The location of the shaft stays 96 may be located anywhere along the pump housing 71 and is preferably above the outlet and preferably close to the middle portion of the pump housing 71. In one embodiment, the stays 96 may include a bolt that engages with a threaded hole in the housing 71. The bolts of the stays 96 may be turned relative to the housing 71 so as to adjust the positions of the stays 96, and thereby define an operating area for the drive shaft 83. A leading end of the bolt may include a PTFE plug or other component that contacts the shaft 83 as needed. The shaft stays 96 need not necessarily come into contact with the drive shaft 83 until the drive shaft 83 becomes radially misaligned, but in some embodiments may maintain constant contact with the shaft 83. The shaft stays 96 may help the drive shaft 83 become properly realigned.

The axial rotor pump may be used for a variety of different applications and is not limited to the belt cooling configuration described above. In some embodiments, the axial rotor pump may be used to deliver liquid cryogen to an elevation above an active portion 3 of an outer surface 2 of a conveyor belt 1. The elevated liquid cryogen may then be used to contact and cool products from above using a waterfall or rain configuration. In another embodiment, the axial rotor pump may be used with any tunnel freezer system to recycle cryogen by moving non-vaporized cryogen back to a sump or cryogen reservoir. In short, the axial rotor pump may be used in any suitable application for moving liquid cryogen from one location to another, regardless of the purpose for movement of the cryogen.

The above and other aspects of the invention will be appreciated from the detailed description and claims. It should be understood that although aspects of the invention have been described with reference to illustrative embodiments, aspects of the invention are not limited to the embodiments described. Also, aspects of the invention may be used alone, or in any suitable combination with other aspects of the invention.

1. A pump for moving a liquid cryogen, comprising:
a housing including a substantially vertical tubular space having an inlet near a bottom of the tubular space and an outlet above the bottom;
a drive shaft in the housing; and
an axial rotor connected to the drive shaft and arranged to be rotated by the drive shaft to pump a liquid cryogen from the inlet toward the outlet;
wherein the pump is constructed and arranged to pump the liquid cryogen for an extended period.

2. The pump of claim 1, wherein a top of the housing includes a clearance hole that permits the drive shaft to seallessly pass through the housing.

3. The pump of claim 1, wherein the tubular space includes an extended neck between the rotor and the top of the housing.

4. The pump of claim 1, further comprising:
a motor shaft outside the housing; and
a magnetic coupling between the motor shaft and the drive shaft.

5. The pump of claim 1, wherein the rotor comprises blades that sweep through an angle of at least forty-five degrees.

6. The pump of claim 1, wherein the rotor comprises blades that sweep through an angle between 200 to 300 degrees.

7. The pump of claim 1, wherein a pitch to rotor diameter ratio is at least 0.5.

8. The pump of claim 1, wherein the rotor has a pitch of at least 1 inch.

9. The pump of claim 1, wherein an outer diameter of the rotor is between 0.5 to 4 inches.

10. The pump of claim 1, wherein the pump is constructed and arranged to achieve a flow rate between 20 to 200 gallons per minute.

11. The pump of claim 1, further comprising shaft stays inside the housing.

12. A method for moving a liquid cryogen, comprising:
providing an axial pump comprising: (i) a housing including a vertical tubular space having an inlet near a bottom of the tubular space and an outlet above the bottom; (ii) a drive shaft in the housing; and (iii) an axial rotor connected to the drive shaft and arranged to be rotated by the drive shaft to pump a liquid cryogen from the inlet toward the outlet;
submerging at least a portion of the axial pump including the inlet in the liquid cryogen held in a container; and
pumping the liquid cryogen from the container via the inlet to the outlet.

13. The method of claim 12, further comprising the step of maintaining a liquid cryogen level in the container.

14. The method of claim 12, further comprising the step of providing the liquid cryogen from the outlet of the axial pump to enable delivery of the liquid cryogen to an active location for use in freezing processes.

15. The method of claim 12, further comprising the step of providing the liquid cryogen from the outlet of the axial pump to enable delivery of the liquid cryogen to a conveyor belt to cool at least a portion of the conveyor belt.

16. The method of claim 12, further comprising the step of providing the liquid cryogen from the outlet of the axial pump to enable delivery of the liquid cryogen to an object from a position below the object.

17. The method of claim 12, further comprising the step of providing the liquid cryogen from the outlet of the axial pump up to an elevated height to enable delivery of the liquid cryogen to an object from a position above the object.
